(19) United States
(12) Patent Application Publication
(10) Pub. No.: US 2005/0144174 A1
(43) Pub. Date: Jun. 30, 2005

(54) Framework for providing remote processing of a graphical user interface

(76) Inventors: Leonid Pesenson, Westfield, NJ (US); Matthew M. Davey, Esher (GB); Carl Carrie, Manhasset Hills, NY (US)

Correspondence Address: DOCKET ADMINISTRATOR;LOWENSTEIN SANDLER PC, 65 LIVINGSTON AVENUE, ROSELAND, NJ, 07068, US

(21) Appl. No.: 10/868,494

(22) Filed: Jun. 15, 2004

Related U.S. Application Data
(60) Provisional application No. 60/533,726, filed on Dec. 31, 2003.

(51) Int. Cl. G06F 7/00

(52) U.S. Cl. 707/10

(57) ABSTRACT

A portion of an application program that would ordinarily be processed on the client side of a client-server computer network can be processed remotely on the server. Under this arrangement, the entire Model portion of the Model-View-Controller (MVC) paradigm can be executed on the server. In general, the portion remaining on the client need only send Model-modifying messages to the server. A declarative programming language is used to define the desired implementation.

### CROSS REFERENCE TO RELATED APPLICATIONS

This application claims the benefit of U.S. Provisional Application Ser. No. 60/533,726, filed by Pesenson et al. on Dec. 31, 2003 and entitled “Framework For Providing Remote Processing of a Graphical User Interface”, which is incorporated herein by reference.

### FIELD OF THE INVENTION

The present invention relates generally to computer networks, and, more particularly, to a framework for providing remote processing of a graphical user interface.

### BACKGROUND OF THE INVENTION

Client/server architecture is a network arrangement which takes advantage of the relative computing power of a server and the individual workstations connected to the server. Under this arrangement, the client and the server work together to accomplish the processing of an application.

In earlier days, the client portion tended to be optimized for user interaction and the server portion provided a centralized, multi-user functionality. However, as workstations have become ever more powerful, more of the application processing has shifted to the client side. For example, many financial trading systems include sophisticated application programs that are largely processed on traders' workstations. Although workstations are more powerful than ever, they cannot keep up with the processing requirements. Accordingly, a need exists to shift some of the processing back onto the server.

### SUMMARY OF THE INVENTION

Portions of an application program that would ordinarily be processed on the client side of a client-server computer network can be processed remotely on the server. Under this arrangement, the entire Model portion of the Model-View-Controller (MVC) paradigm can be executed on the server. In general, the portion remaining on the client need only send Model-modifying messages to the server. A declarative programming language is used to define the desired implementation.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 is a block diagram illustrating an arrangement in which the Model component resides entirely on a server portion of a client/sever network;

FIG. 2 illustrates an exemplary process being implemented according to an embodiment of the invention; and

FIG. 3 illustrates an application object view of the process being implemented in FIG. 2.

### DESCRIPTION OF PREFERRED EMBODIMENTS

It is to be understood that all program code and data used to implement the inventive methods reside on computer readable media and run on one or more computer systems including standard computer components and operating systems such as Microsoft Windows, UNIX, and LINUX, as known in the art. Furthermore, it is to be appreciated that the word network as used herein is to be broadly construed to include a group of computers and associated devices connected by communications facilities. The network connections may either be permanent (e.g., cables) or temporary (e.g., through a telephone or a wireless device). Furthermore, the network may include either a local area network (LAN) or a wide area network (WAN), or a combination thereof. Although certain of the following examples describe the inventive methods implemented using the Microsoft NET (TM) framework, it is to be understood that the inventive methods can be performed by software written in various programming languages, using various platforms and operating system, as known in the art.

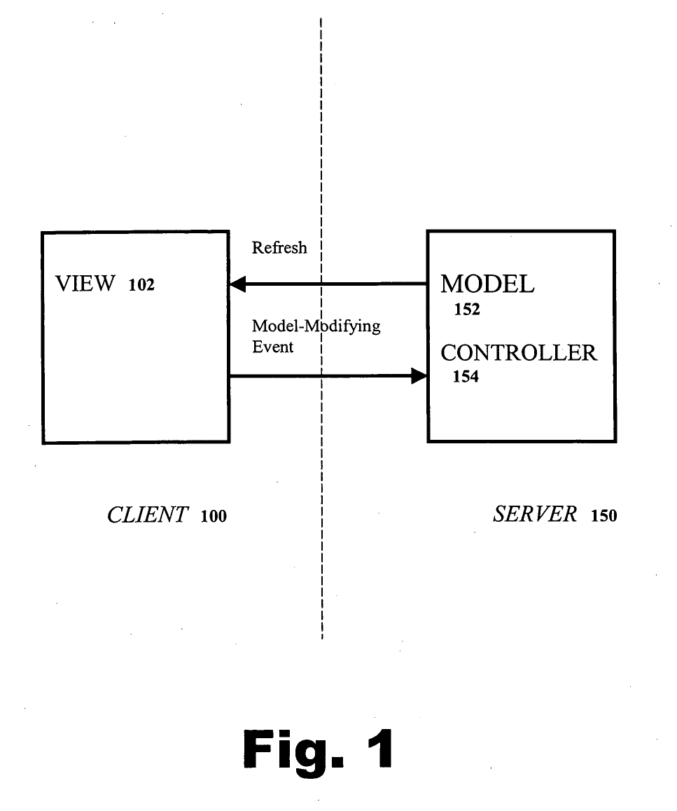

FIG. 1 is a block diagram illustrating a Model-View-Controller (MVC) arrangement in which a Model 152 resides entirely on a server 150 of a client/server network. The server 150 can also includes a Controller 154. A client 100 includes a View 102. In general, the Model 152 comprises the objects that make up the underlying problem domain. For example, these may include an application program to perform a calculation or query a database. The View 102 comprises the presentation of information to a user. Typically, the View 102 includes screens containing information from the Model 152. The information shown on the screens may be in the form of fields, windows, tables, etc. Furthermore, the View 102 may contain either read-only or editable information. The Controller 154 controls the input from the user. Typically, the Controller 154 gathers input from a keyboard and a mouse device.

As is well known in the art, the MVC paradigm requires that developers split an application into separate Model, View, and Controller components so that it is easier to change or replace any one part without affecting the other parts. The present invention provides the developer a way to place the Model 152 entirely on the server 150, rather than apportioning the Model between the client 100 and the server 150. This arrangement alleviates much of the processing burden on the client side, allows software upgrades to be done more easily since only a single copy of the application software need be maintained, and provides a more secure processing environment.

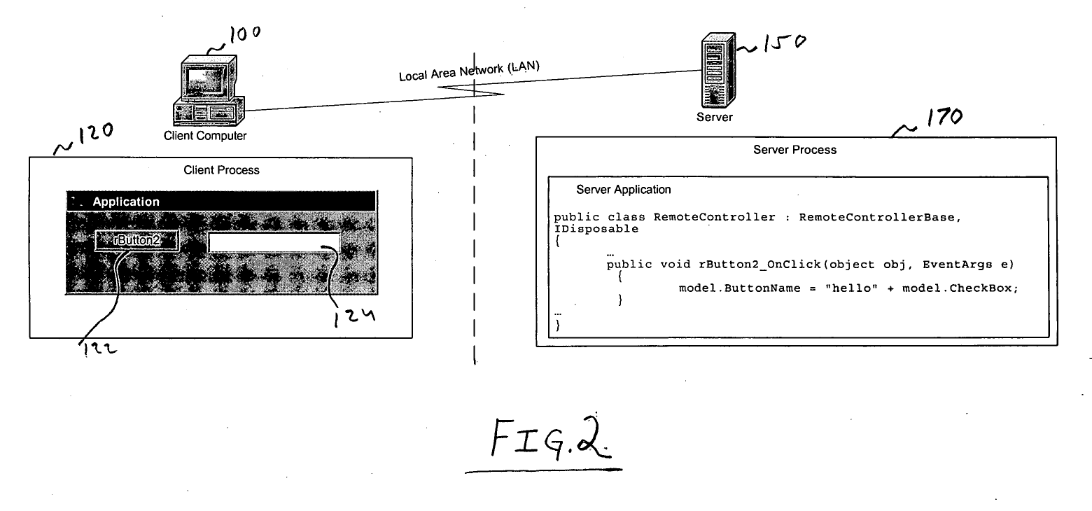

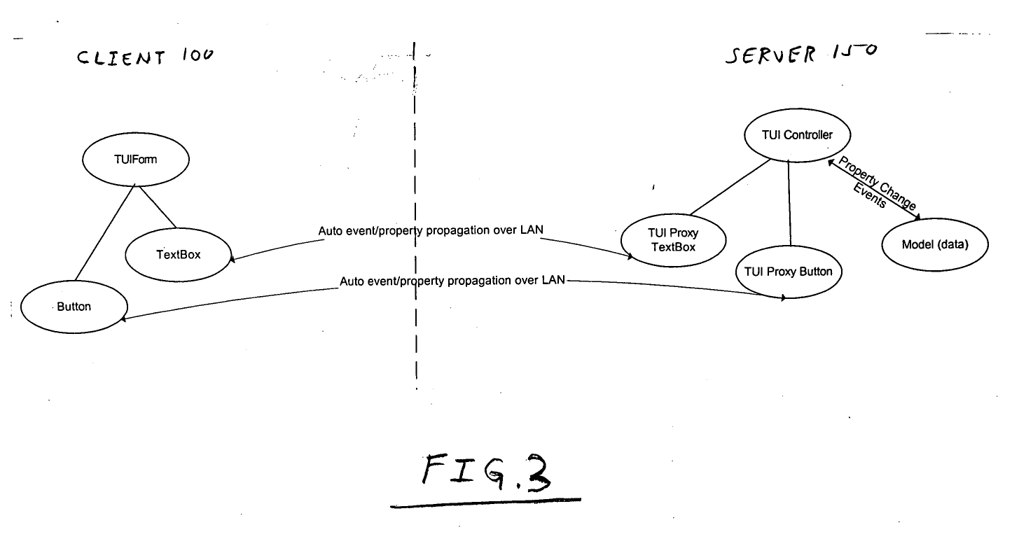

FIG. 2 illustrates an exemplary process being implemented in accordance with the present invention. The example comprises the implementation of a button 122 and a text box 124. As shown in FIG. 2, a client process 120 is displayed on the client computer 100. Let us assume that when a user clicks on the button 122, it is desired that the contents of the text box 124 change. Conventionally, an event handler on the client computer 100 might be used to catch the ‘Click’ event of the button 122 and then set the text box 124 to a particular value. However, the present invention accomplishes the same result in a different manner without mixing presentation and data. FIG. 3 is an object representation of the exemplary client side widgets and the server-side proxy widgets described herein.

The following code fragments illustrates one way that the client process could be defined:

public class Form1 : JPM.EDG.TUI.Client.TUIForm
{

private System.Windows.Forms.Button rButton2;
private System.Windows.Forms.TextBox rTextBox1;

...
}

Note that there is no ‘Click’ event handler in the above code. That is because events, processing and business logic are performed on the server 150. This is not to say that every movement of the mouse is tracked; rather only events that are significant to altering the state of the model are handled on the server 150.

On the server 150, a controller that is linked to the form defined above (“Form 1”) can be defined. The following code fragment is an example of event handler code that could be used to define the controller on the server 150.

public class RemoteController : RemoteControllerBase,
IDisposable
{
...
public void rButton2_OnClick(object obj, EventArgs e)
{

model.ButtonName = “hello” + model.CheckBox;

}
...
}

The present invention makes extensive use of binding. For example, the present invention supports data binding, menu binding, and command binding.

Using the above Form1 client, on the server 150, running in a different process, data binding can be defined as follows:

ServerControl comp = FindControl(“rButton2”);
comp.DataBindings.Add(“Text”, model, “ButtonName”);

Essentially, the property “ButtonName” on the object model is bound to the text property of the rButton2 widget which resides in another process, on another machine.

Now, whenever the property ButtonName changes, the Text property on the client widget rButton2 will change automatically.

The present framework offers menu bindings, a feature that doesn't exist in Microsoft NET today. Menu bindings are declared in a similar format to data bindings on a widget. The following code fragment provides an example of how menu bindings could be declared.

ServerControl comp = FindControl(“rDataGrid1”);
comp.MenuBindings.Add(“Hello”, “Action_Click”,
this, “Hello”);
comp.MenuBindings.Add(“Hello”, “Pre_Click”, “Hello”);
comp.MenuBindings.Add(“GoodBye”, “Action_Click”, this,
“GoodBye”);

In the above code, the data grid rDataGrid1 has two context menus bound to the widget. The first, “Hello”, has a ‘Pre’ method executed if the menu is clicked, followed by the ‘Action’ method executed on the server. The second, “Goodbye” has the method ‘GoodBye’ executed in the server process, when the user selected the ‘GoodBye’ context menu in the client application.

Command bindings are similar to menu binding, but are used to declaritively specify a method to be called sever side when a standard .NET event is fired client side for a widget. In the following code, when a user double-clicks on the data grid within the client application, the server method ‘DisableEnableOption’ is executed.

ServerControl comp = FindControl(“rDataGrid1”);
comp.CommandBindings.Add(“Action_DoubleClick”, this,
“DisableEnableOption”);

Microsoft .NET, and most other frameworks, offer no help in caching and throttling data. For example, suppose an application receives live stock market prices which change at a faster rate than the widget that is employed to display the stock prices. In this case, there should be some way to buffer the stock price data. The present framework also provides core level caching and throttling, thus removing the problem from the application developer.

Within Microsoft NET, the data grid functionality is extensive, but not declarative. A simple example of this is changing the color of a cell in a column. Normally a NET developer would have to code a custom column, and then override the Paint methods to change the background color of a cell in a grid. The present framework provides a declarative way of doing this:

First define a column in the application (server side)

ColumnStyleUI colUI2 = new
ColumnStyleUI(“Name.FirstName”);
colUI2.HeaderText = “First name”;
colUI2.Width = 150;
colUI2.BackgroundColor(new
ColumnStyleUIHandler(DecideBackColour));

Then add the column to the data grid:

RDataGridTableStyle tableStyle = new
RDataGridTableStyle( );
tableStyle.DataGridColumnStyles.Add( colUI2);
StubDataTable sdt = FindControl(“rDataGrid1”) as
StubDataTable;
sdt.TableStyle = tableStyle;

The client side grid will now be displayed with a column, “First Name”, which is populated from the server side data model. Important points to note about the above code include the following:
The code is run on the server, but the rDataGrid1 (in this case a Microsoft DataGrid widget) is actually running on the client in another process, on another machine.
The column we defined is told to follow the path “Name.FirstName” on the model object—the model object being where the data is. In the framework paths can be used in a number of places—again a declarative way of describing where the data is.

The ‘BackgroundColor’ property on the color is declared as a delegate (‘DecideBackColour’):

public bool DynamicReadOnly(object row, string column)
{

Customer c = row as Customer;
if (null != c && c.SupportLevel4 == “Silver”)
{

return true;

}
return false;

}

This delegate is called whenever the client grid needs to know which color to paint a cell in the “First Name” column. Again this function is run on the server, even though the data grid is on the client.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

1. A system for providing a remote graphical user interface framework in a client-server network, comprising:
a server that executes a Model portion of an application program;
a client that executes a View portion of the application program;
wherein the client sends Model-modifying messages to the Model portion via the client-server network and the server responds by sending View-modifying messages to the client via the client-server network.

2. The system of claim 1, wherein the server further includes a Controller portion of the application program.

3. The system of claim 1, wherein the Model-modifying messages are associated with events that alter the state of the Model.

4. The system of claim 1, wherein a declarative programming language defines the Model portion and the View portion.

5. A method for providing remote processing of a graphical user interface in a client-server network, comprising the steps of:
providing a Model portion of an application program entirely on a server;
providing a View portion of the application program entirely on a client;
wherein the client sends Model-modifying messages to the Model portion on the server and the server responds by sending View-modifying messages to the client.

6. The method of claim 5, further including the step of providing a Controller portion of the application program on the server.

7. The method of claim 5, wherein the Model-modifying messages are associated with events that alter the state of the Model.

8. The method of claim 5, wherein a declarative programming language defines the Model portion and the View portion.

9. A program storage device readable by a machine, tangibly embodying a program of instructions executable on the machine to perform method steps for providing a remote graphical user interface in framework in a client-server network, the method steps comprising:
providing a Model portion of an application program entirely on a server;
providing a View portion of the application program entirely on a client;
wherein the client sends Model-modifying messages to the Model portion on the server and the server responds by sending View-modifying messages to the client.
